(19) United States
(12) Patent Application Publication
(10) Pub. No.: US 2017/0009526 A1
(43) Pub. Date: Jan. 12, 2017

(54) UPRIGHT LADDER

(71) Applicant: Zeynal Alagoz, Edmonton (CA)

(72) Inventor: Zeynal Alagoz, Edmonton (CA)

(21) Appl. No.: 14/796,981

(22) Filed: Jul. 10, 2015

(51) Int. Cl. E06C 1/38; E06C 7/08; E06C 1/24

(52) U.S. Cl. CPC E06C 1/381; E06C 1/24; E06C 7/082

(57) ABSTRACT

A climbing apparatus comprising a base, an upright member extending vertically upwardly from the base and having first and second sides and first and second carriages slidably locatable along the first and second side of the upright member. The apparatus further comprises a foot support associated with each of the first and second carriages, the carriages being rotatable supported by the carriage; and an upright engaging member extending from each foot support to selectably engage the upright when the foot support is rotated to a first orientation and to disengage from the column when the foot support is rotated to a second orientation.

### BACKGROUND OF THE INVENTION

1. Field of Invention

The present invention relates generally to ladders in general and in particular to a method and apparatus for permitting a user to climb a vertical column.

2. Description of Related Art

Ladders are a common implement use for enabling a user to reach heights not otherwise accessible to them. Conventional ladders however, have several disadvantages their use. In particular, the rungs of the ladder may be prone to becoming slippery in wet or adverse conditions or when the user has limited grip available from their shoes. This difficulty may be exacerbated on worksites in which the user is required to walk through mud and or dirt prior to using the ladder. The potential risks associated with a user's foot slipping off of a ladder rung include death or serious injury from the resulting fall.

Landers conventionally fall into one of two configurations, a leaning ladder or an A-frame ladder. A-frame ladders typically have two sides forming in a frame so as to be self-supporting in the location which they are placed. Conversely, a leaning or extension ladder includes a single elongate element having rungs therealong which may be leaned against a structure to support it. In each of these classes of ladders, the main climbing portion of the ladder is angled so as to enable the user to climb without fear or risk of falling backwards off the ladder. A disadvantage of such angle is that the ladder requires a larger ground area in order to permit a sufficiently wide base for the ladder to climb to higher heights. Additionally, leaning ladders also suffer from the disadvantage of requiring a firm surface against which to lean in order to be operated. This may be difficulty in locations where the object to be reached is suspended above the user with limited surrounding rigid objects.

### SUMMARY OF THE INVENTION

According to a first embodiment of the present invention there is disclosed a climbing apparatus comprising a base, an upright member extending vertically upwardly from the base and having first and second sides and first and second carriages slidably locatable along the first and second side of the upright member. The apparatus further comprises a foot support associated with each of the first and second carriages, the carriages being rotatable supported by the carriage; and an upright engaging member extending from each foot support to selectably engage the upright when the foot support is rotated to a first orientation and to disengage from the column when the foot support is rotated to a second orientation.

The upright may include front and rear surfaces. The front surface may include a plurality of horizontal projections extending therefrom adapted to engage the upright engaging members of the foot supports. The horizontal projections may comprise lips having horizontal top surfaces.

The first and second sides of the upright may include tracks therein. The tracks may comprise c-shaped openings. The first and second carriages may include rollers locatable within the tracks of the upright. The tracks may include lips extending towards each other to contain the rollers of the carriages therein.

The first orientation may be a lowermost position. The second orientation may be a raised position such that the upright engaging member is rotated away from the upright. The upright engaging members may comprise posts extending towards each other from the food supports.

The foot support may include a planar foot platform. The foot support may include a heal cup adapted to surround a heel of a user's foot to retain the foot upon the foot platform. The heal cup may be slidably supported by the foot platform and biased towards the upright. The foot support may include a top member adapted to extend over the foot to retain the food upon the foot platform. The top member may include an open side. The foot support may be pivotable about a pivot located above the foot platform.

At least one of the carriages may include a post extending substantially therefrom to a support tray. The apparatus may further comprise a waist strap extending from the post adapted to surround a torso of a user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a ladder according to a first embodiment of the present invention.

FIG. 2 is an exploded view of the carriage and ladder assembly of the ladder of FIG. 1.

FIG. 3 is a cross-sectional view of the upright and carriage of the ladder of FIG. 1.

FIG. 4 is a side view of one of the foot supports of the ladder of FIG. 1 at a first position.

FIG. 5 is a side view of one of the foot supports of the ladder of FIG. 1 at a second position.

FIG. 6 is a detailed perspective view of the bottom portion of the ladder of FIG. 1.

FIG. 7 is a bottom plan view of the ladder of FIG. 1.

### DETAILED DESCRIPTION

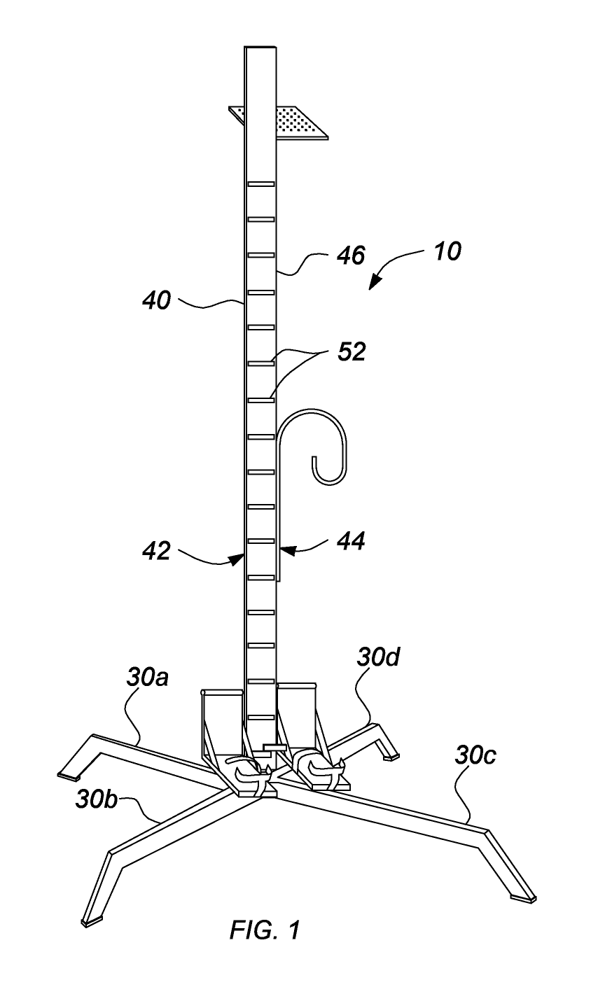

Referring to FIG. 1, a ladder according to a first embodiment of the invention is shown generally at 10. The ladder 10 is formed of a base 12 having an upright member 40 extending substantially vertically therefrom. A pair of foot supports 80 are supported by a pair of longitudinally slidable carriages 60 to a plurality of locations along the upright to support the feet of a user (not shown).

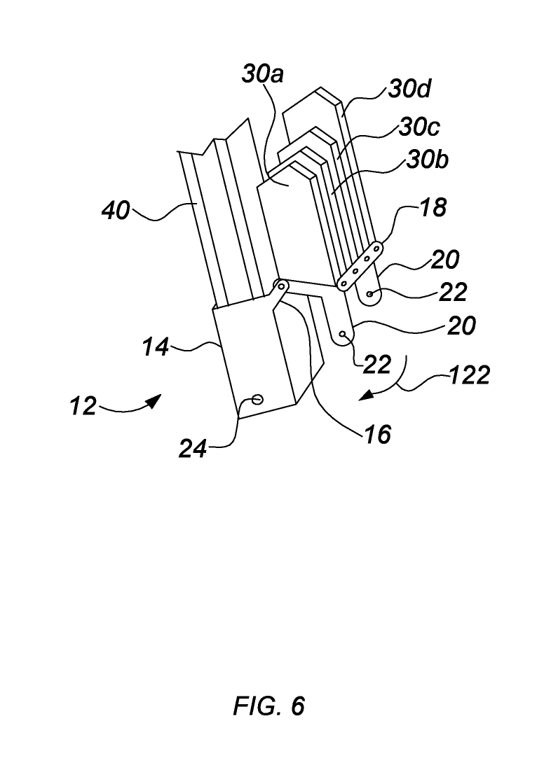

With reference to FIG. 6, the base is formed of a bottom cap 14 secured to the bottom end of the upright 40. The bottom cap 14 includes a pivot arm 16 extending therefrom pivotally supporting a base bracket 18. As illustrated in FIG. 6, the base bracket 18 includes locking arms 20 extending therefrom and may be rotated in a direction generally indicated at 122 into engagement against the bottom cap 14 such that the locking arms 20 are located to either side thereof. Thereafter a pin 26 may be passed through bores 22 in the locking arms and a corresponding bore in the bottom cap 14 to secure the base bracket 18 thereto.

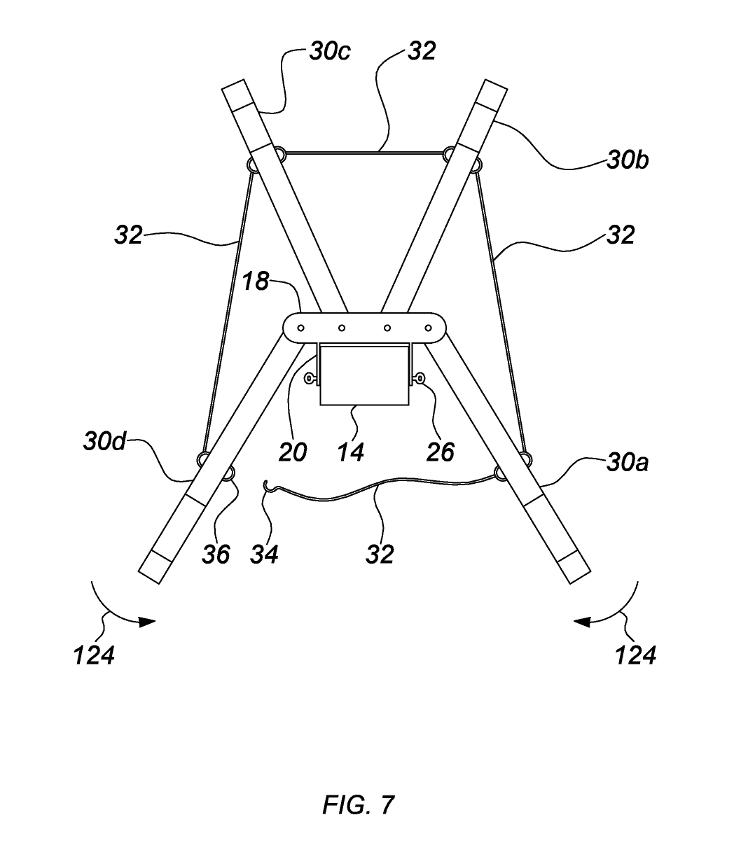

The base bracket 18 pivotally supports first, second, third and fourth arms 30a, 30b, 30c and 30d therefrom which may be rotated about parallel axes to be arranged to extend substantially radially from the upright. As illustrated in FIG. 7, the arms 30a, 30b, 30c and 30d may be rotated in directions generally indicated at 124 so as to spread the arms around the upright 40. The arms may include flexible connectors, such as cables 32 chains or the like therebetween sized to fix the arms at desired orientations from the base to provide sufficient stability to the apparatus. In particular, one of the cables 33 between one set of the arms 30a and 30b may extend from the first arm and include a hook 34 at a distal end thereof adapted to engage upon a corresponding loop on the fourth arm. In such a manner the arms may be folded to be parallel for storage as illustrated in FIG. 6 or extended to support the upright as illustrated in FIG. 7.

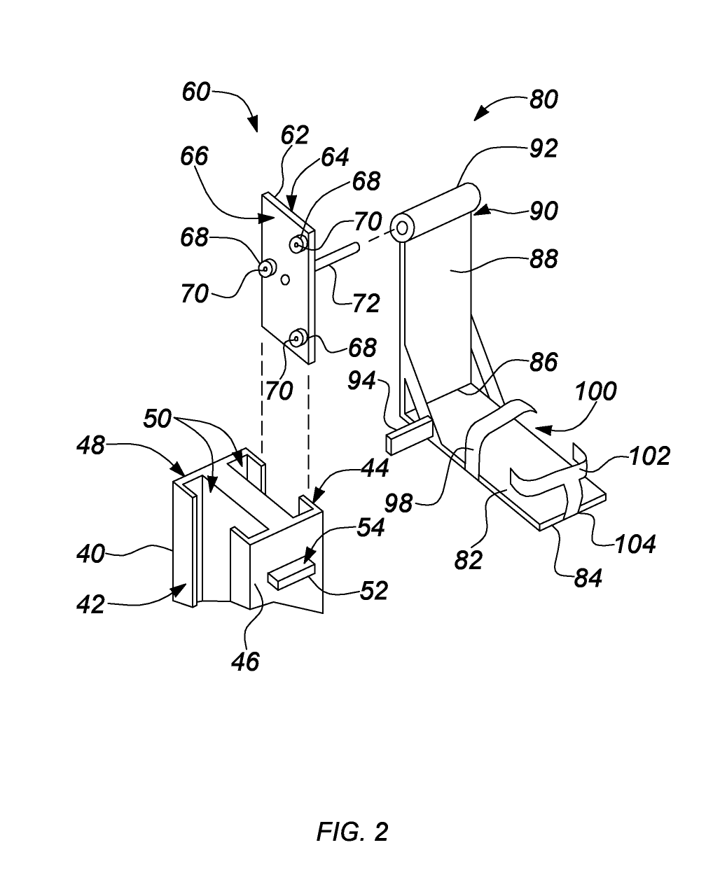

Turning now to FIGS. 1 and 2, the upright 40 comprises an elongate member having first and second sides, 42 and 44, respectively and front and rear surfaces, 46 and 48, respectively. The first and second sides 42 and 44 include elongate channels 50 therein adapted to receive the carriages as will be more fully described below. The front surface 46 includes a plurality of protrusions 52 extending therefrom. As illustrated in FIGS. 1 and 2, the protrusions 52 may comprises substantially rectangular shelves having planar top surfaces 54.

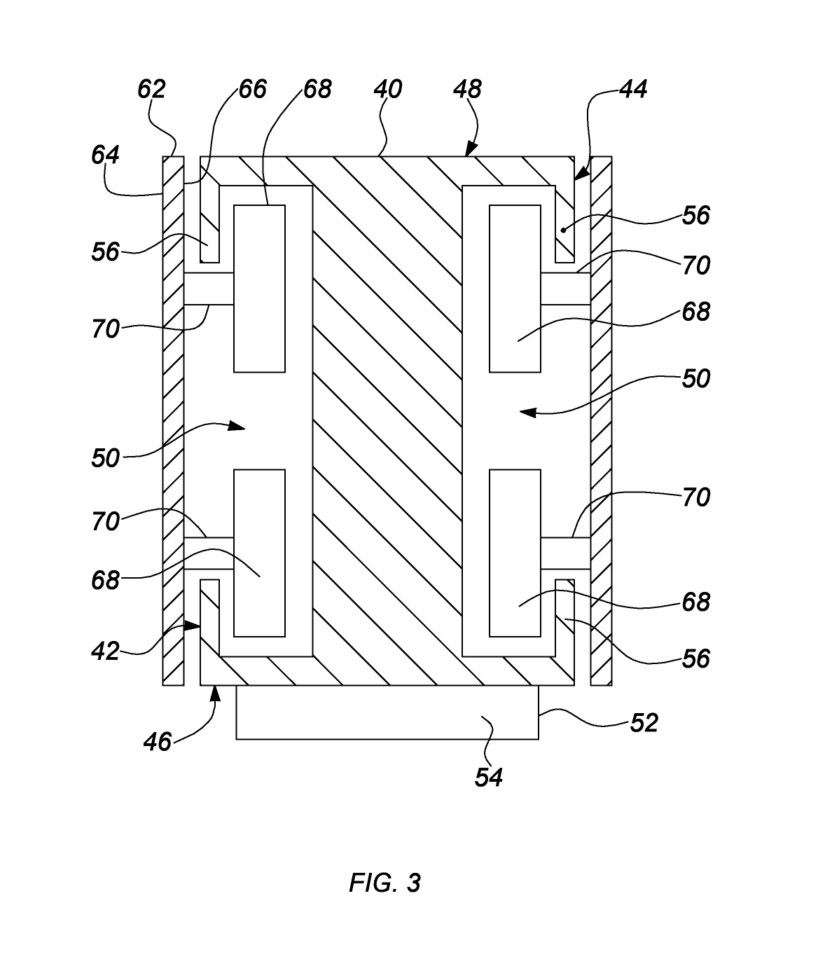

Turning now to FIG. 3, a cross sectional view of the upright is shown in which the channels 50 located within each of the first and second sides 42 and 44 thereof. As illustrated, the channels 50 may comprise substantially c-shaped channels having retaining panels 56 extending from the sides thereof to retain the carriage therein as will be more fully described below.

Each carriage 60 comprises a base panel 62 having front and rear surfaces, 64 and 66, respectively. The rear surface 66 supports a plurality of rollers 68 on roller pins 70 extending therefrom. The front surface 64 includes a foot support pin 72 extending therefrom. As illustrated, the carriage 60 may include three rollers 68 although it will be appreciated that more or less may also be utilized. The rollers 68 are sized and spaced apart by a distance sufficient to be located within the channel 50 such that the retaining panels 56 surround the rollers 68 to keep them within the channel 50. The roller pins 70 have a length selected to space the rollers 68 apart from the rear surface

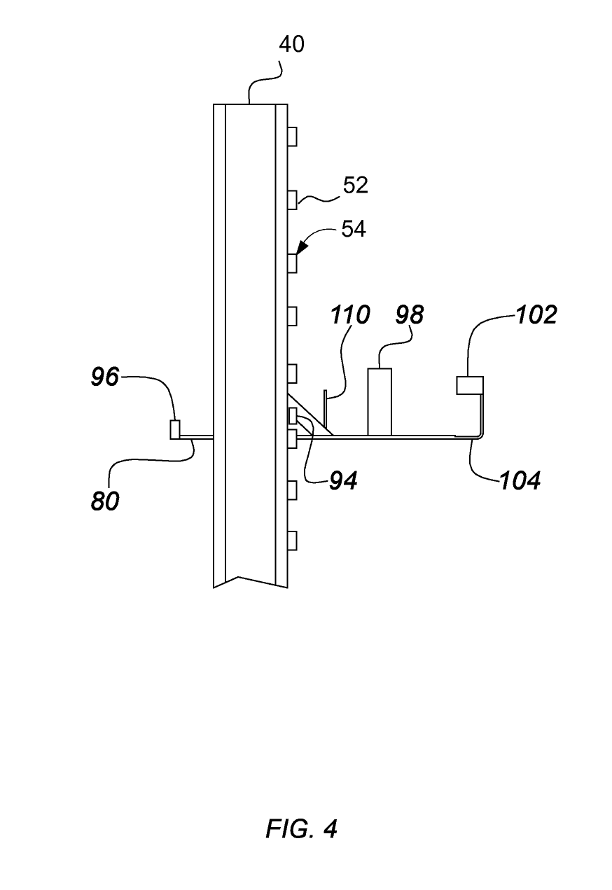

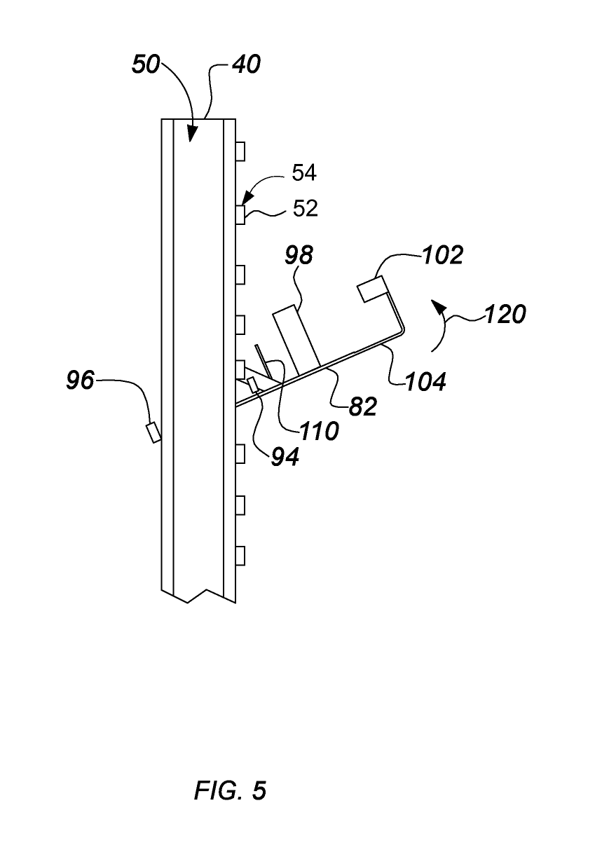

The foot support 80 comprises a planar foot supporting platform 82 extending between front and rear ends, 84 and 86, respectively. The front end of the platform 82 includes an upright panel 88 extending therefrom to a top distal end 90. The top distal end includes a sleeve 92 adapted to receive the foot support pin 72 therein. In such a manner the foot support 80 may be pivotally supported about the foot support pin 72. The foot support 80 includes an upright engaging body 94 extending from a side surface proximate to the upright at a position selected to be in front of the upright as illustrated in FIG. 4. The upright engaging body 94 is sized to correspond to the top surfaces 54 of the protrusions 52 so as to be engageable thereon. Optionally, as illustrated in FIGS. 4 and 5, the platform 82 may also include a rear stop bar 96 extending towards the same side as the upright engaging body and positioned to be located to the rear of the upright 40.

The platform 82 includes a top band 98 having an open side, generally indicated at 100 extending above the platform which is positioned to extend over the foot of a user located on the platform and thereby to retain the user's foot upon the platform when in use. Additionally, the platform also includes a rear heal cup 102 extending upwardly from the rear edge 84 of the platform 82. The heal cup 102 includes a cup portion 104 sized and shaped to correspond to a users' heal and an upright portion 106 spacing the cup portion 104 above the platform. Optionally, the heal cup 102 may include a base portion 108 slidably located within or below the platform 82 and biased towards the front edge 86 of the platform to retain the user's foot therein. As illustrated in FIGS. 4 and 5, the platform 82 may include a toe wall 110 located such that the user's foot may be located between the toe wall 110 and the heal cup 102.

In operation as illustrated in FIGS. 4 and 5, a user's foot may be located on the platform 82 between the toe wall 110 and heal cup 102 such that the top band 98 is located thereover. In the resting position with the user's weight upon the platform 82, the platform will be rotated down until upright engaging body 94 engaged against the front surface 46 of the upright 40. Thereafter the user's weight will move the upright engaging body 94 onto the top surface 54 of the next protrusion 52. When the user wishes to climb, they may lift their foot thereby rotating the platform 82 in an upward direction generally indicated at 120 so as to disengage the upright engaging body 94 wherein the rear stop bar 96 engages the rear surface 48 of the upright preventing further rotation. Continued upward movement of the user's foot will thereafter lift the foot support 80 and carriage 60 upward until a sufficient foot height has been reached. Once the user thereafter presses their foot back down, the platform 82 will be rotated back to the orientation shown in FIG. 4 and the upright engaging body 94 engaged upon a higher protrusion 52. In such a manner, the user may then climb the upright without lifting their foot off of the platform and thereby reducing the risk of slips or the like.

Optionally, as illustrated in FIG. 1, one or more of the carriages may include a post 140 extending therefrom adapted to have a tray 142 or the like located thereon. Additionally, the safety belts or the like may be secured around the user to the post to prevent accidental falls or the like. Additionally, as illustrated in FIG. 1, the legs may include rollers at the distal ends thereof as are commonly known to enable easy repositioning of the apparatus.

While specific embodiments of the invention have been described and illustrated, such embodiments should be considered illustrative of the invention only and not as limiting the invention as construed in accordance with the accompanying claims.

What is claimed is:

1. A climbing apparatus comprising
a base;
an upright member extending vertically upwardly from said base and having first and second sides;
first and second carriages slidably locatable along said first and second side of said upright member;
a foot support associated with each of said first and second carriages, said carriages being rotatable supported by said carriage; and
an upright engaging member extending from each foot support to selectably engage said upright when said foot support is rotated to a first orientation and to disengage from said column when said foot support is rotated to a second orientation.

2. The apparatus of claim 1 wherein said upright includes front and rear surfaces.

3. The apparatus of claim 2 wherein said front surface includes a plurality of horizontal projections extending therefrom adapted to engage said upright engaging members of said foot supports.

4. The apparatus of claim 3 wherein said horizontal projections comprise lips having horizontal top surfaces.

5. The apparatus of claim 1 wherein said first and second sides of said upright includes tracks therein.

6. The apparatus of claim 5 wherein said tracks comprise c-shaped openings.

7. The apparatus of claim 6 wherein said first and second carriages include rollers locatable within said tracks of said upright.

8. The apparatus of claim 7 wherein said tracks include lips extending towards each other to contain said rollers of said carriages therein.

9. The apparatus of claim 1 wherein said first orientation is a lowermost position.

10. The apparatus of claim 1 wherein said second orientation is a raised position such that said upright engaging member is rotated away from said upright.

11. The apparatus of claim 1 wherein said upright engaging members comprise posts extending towards each other from said food supports.

12. The apparatus of claim 1 wherein said foot support includes a planar foot platform.

13. The apparatus of claim 12 wherein said foot support includes a heal cup adapted to surround a heal of a user's foot to retain said foot upon said foot platform.

14. The apparatus of claim 13 wherein said heal cup is slidably supported by said foot platform and biased towards said upright.

15. The apparatus of claim 12 wherein said foot support includes a top member adapted to extend over said foot to retain said food upon said foot platform.

16. The apparatus of claim 15 wherein said top member includes an open side.

17. The apparatus of claim 12 wherein said foot support is pivotable about a pivot located above said foot platform.

17. The apparatus of claim 1 wherein at least one of said carriages includes a post extending substantially therefrom to a support tray.

18. The apparatus of claim 17 further comprising a waist strap extending from said post adapted to surround a torso of a user.
